(19) United States
(12) Patent Application Publication
(10) Pub. No.: US 2025/0038635 A1
(43) Pub. Date: Jan. 30, 2025

(54) WHEEL-BASED ELECTROMAGNETIC AUTOMOTIVE POWER ASSEMBLY

(71) Applicant: John Jay Wonders, Wind Lake, WI (US)

(72) Inventor: John Jay Wonders, Wind Lake, WI (US)

(21) Appl. No.: 18/783,841

(22) Filed: Jul. 25, 2024

Related U.S. Application Data
(60) Provisional application No. 63/529,519, filed on Jul. 28, 2023.

(51) Int. Cl. H02K 49/04; B60K 7/00; B60T 1/06; F16D 65/00; F16D 65/12

(52) U.S. Cl. CPC H02K 49/043; B60K 7/0007; F16D 65/0068; F16D 65/123; F16D 65/125; B60T 1/065

(57) ABSTRACT

A wheel-based electromagnetic automotive power assembly for an electric vehicle. The wheel-based electromagnetic automotive power assembly has a series of alternating charged magnets communicating with a circumferential edge of a brake rotor disc. A plurality of alternating fixed electromagnets is supported by a brake caliper operatively associated with the brake rotor disc to both actuate a braking action to a respective motive wheel of the electric vehicle operatively associated with the brake rotor disc, and, when selectively powered by the driver, the alternating powered electromagnets magnetically urge the series of alternating charged magnets to rotate the brake rotor disc and thus the operatively associate motive wheel.

### CROSS-REFERENCE TO RELATED APPLICATION

This application claims the benefit of priority of U.S. provisional application No. 63/529,519, filed 28 Jul. 2023, the contents of which are herein incorporated by reference.

### BACKGROUND OF THE INVENTION

The present invention relates to electric vehicle power systems and, more particularly, to a wheel-based electromagnetic automotive power assembly.

Electric vehicles (EVs) are heralded as eco-friendly vehicles that can reduce dependency on fossil fuels which are associated with global warning and autocratic regimes.

Some of the reasons given by drivers who have not transitioned from gasoline internal combustion engine vehicles to EVs concern the frequency that electric vehicles must recharge, how long that recharging takes, and the scarcity of recharging stations to do said recharging when the driver is away from home base.

Conventional EVs use an electric motor and rechargeable battery pack to power their wheels. The battery stores energy from a charging station, which is then converted from direct current (DC) to alternating current (AC) to power the motor. The motor uses electromagnets to create magnetic fields that rotate a shaft, which turns the wheels through a cog. This process creates torque, which gives EVs their instant acceleration.

Some EVs also use in-wheel motors that are installed directly inside the wheel rim. This eliminates the need for a transmission and ensures that the motor's full power is available at the wheel, enabling energy efficiencies. However, these in-wheel motors have limitations.

As can be seen, there is a need for a wheel-based electromagnetic automotive power assembly, wherein the vehicle's battery powers magnets are fixed along the circumferential surface of a brake rotor in an alternating charged arrangement.

### SUMMARY OF THE INVENTION

Wheel-based motors provide a more efficient means to power an electric vehicle. The present invention is an improvement on current in-wheel motor systems to reduce the number of moving parts needed to provide power to the wheels of a vehicle, which in turn should improve battery performance, power efficiency, and vehicle driving range, thereby enticing more adopter of EVs. The wheel-based electromagnetic automotive power assembly of the present invention allows all the power to be used to just drive the wheels.

In one aspect of the present invention, a wheel-based electromagnetic automotive power assembly for an electric vehicle provides the following: a series of alternating charged magnets communicating with a circumferential edge of a brake rotor disc; and a plurality of alternating powered electromagnets supported by a brake caliper operatively associated with the brake rotor disc to actuate a braking action to a respective motive wheel of the electric vehicle operatively associated with the brake rotor disc, and wherein the alternating powered electromagnets, when selectively powered, magnetically urge the series of alternating charged magnets to rotate the brake rotor disc.

In another aspect of the present invention, the wheel-based electromagnetic automotive power assembly further includes wherein the series of alternating charged magnets are fixed to the circumferential edge of the brake rotor disc, or wherein the series of alternating charged magnets extend from the circumferential edge of the brake rotor disc toward a center thereof at least one inch.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention.

FIG. 2 is a flow chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a wheel-based electromagnetic automotive power assembly.

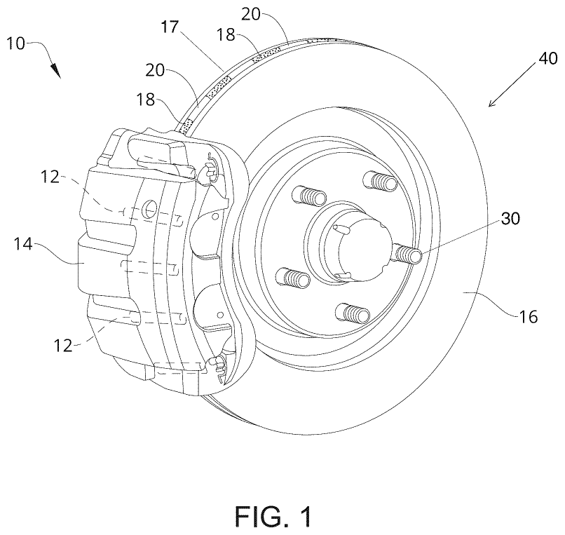

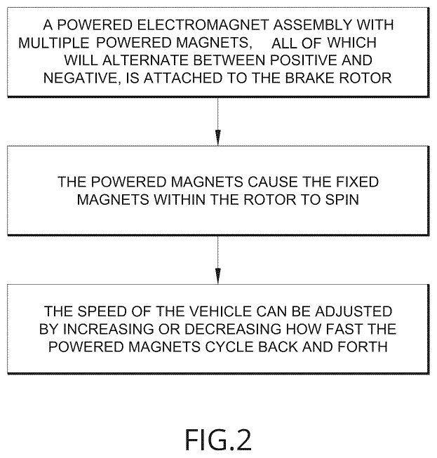

Referring to FIGS. 1 and 2, an embodiment of the present invention provides a wheel-based electromagnetic automotive power assembly 10 for an electric vehicle.

The electric vehicle (not shown) has motive wheels (not shown), including the wheel hubs (not shown), wheel rims (not shown), and brake rotor flanges, and the elements and components thereof, which may be formed from any suitable material, including various metallic or plasticized materials.

The brake rotor flange is configured for selective attachment and detachment of a brake rotor 40 using any suitable attachment devices suitable for selective attachment and detachment of the brake rotor may be used, such as, for example, a plurality of threaded brake rotor fasteners 30, including threaded bolts or a combination of threaded studs and threaded nuts.

The brake rotor 40 comprises a cylindrical ring (disc brake) 16 and a brake caliper 14 that is configured for selective frictional engagement and friction braking of the vehicle via brake pads provided by the brake caliper 14. The cylindrical ring 16 may include a plurality of circumferentially spaced apart fixed magnetizable material or magnets 18 and 20. The fixed magnets 18 and 20 are an alternating arrangement of positive fixed magnets 18 and negative fixed magnets 20.

In certain embodiments, the series of radially spaced apart fixed magnets 18 and 20 may be sandwiched between the cylindrical ring (disc brake) 16 and another flange 17. In this embodiment, each of the magnets 18 and 20 may extend from the circumferential edge toward the shared axis of the cylindrical ring 16 and flange 17.

The brake caliper assembly 14 is configured for actuation that provides a braking action to the respective motive wheels by way of the standard brake pads supported by the brake caliper assembly 14. The brake caliper assembly 14 is configured to house alternating powered electromagnets 12 so that when the cylindrical ring 16 rotates through the channel defined by the brake caliper assembly 14 the circumferentially spaced apart fixed, alternating positive and negative magnets 18 and 20 electromagnetically associate with the alternating powered electromagnets 12 housed in the brake caliper assembly 14.

The wheel-based electromagnetic automotive power assembly 10 provides alternating positive and negative fixed magnets 18 and 20 to move the vehicle forward or backwards. The powered magnets 12 housed in the brake caliper assembly 14 will cause the fixed magnets 18 and 20 to spin. The speed of the vehicle can be adjusted by increasing or decreasing how fast the powered magnets cycle back and forth.

A method of making the present invention may include the following. A manufacturer or retrofitter may take a standard disc brake system and reengineer it by adding electromagnets to the caliper assembly 14 and modifying the rotor discs 16 and 17 to support fixed magnets 18 and 20 between them alternating between positive and negative, whereby alternating the charge of the electromagnetics will cause disc 16 to spin, moving the vehicle forward.

In some embodiments, the fixed magnets 18 and 20 could be placed on the face of the disc rotor. This could potentially provide more power to turn the wheels, but an alternative braking system would need to be developed.

A method of using the present invention may include the following. The automotive in-wheel electromagnetically powered assembly 10 may be used to move electric vehicles forward and backwards without the need for a motor or transmission. The power from the batteries would go directly to powering the magnetics and moving the vehicle, reducing the number of other components needed to move the vehicle.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A wheel-based electromagnetic automotive power assembly for an electric vehicle, the wheel-based electromagnetic automotive power assembly comprising:
a series of alternating charged magnets communicating with a circumferential edge of a brake rotor disc; and
a plurality of alternating fixed electromagnets supported by a brake caliper assembly, wherein the brake caliper assembly is operatively associated with the brake rotor disc to actuate a braking action to a respective motive wheel of the electric vehicle operatively associated with the brake rotor disc, and wherein the alternating powered electromagnets, when selectively powered, magnetically urge the series of alternating charged magnets to rotate the operatively associated motive wheel.

2. The wheel-based electromagnetic automotive power assembly of claim 1, wherein the series of alternating charged magnets are fixed to the circumferential edge of the brake rotor disc.

3. The wheel-based electromagnetic automotive power assembly of claim 1, wherein the series of alternating charged magnets extend from the circumferential edge of the brake rotor disc toward a center thereof at least one inch.
